(19) United States
(12) Patent Application Publication
(10) Pub. No.: US 2016/0370612 A1
(43) Pub. Date: Dec. 22, 2016

(54) Liquid Crystal Panel and Liquid Crystal Display

(71) Applicant: SHENZHEN CHINA STAR OPTOELECTRONICS TECHNOLOGY CO., LTD., Shenzhen City, Guangdong (CN)

(72) Inventor: Chang XIE, Shenzhen, Guangdong (CN)

(73) Assignee: Shenzhen China Star Optoelectronics Technology Co., Ltd., Shenzhen, Guangdong (CN)

(21) Appl. No.: 14/426,193

(22) PCT Filed: Dec. 29, 2014
(86) PCT No.: PCT/CN2014/095380

§ 371 Date: Mar. 5, 2015

(30) Foreign Application Priority Data
Dec. 12, 2014 (CN) 201410768758.X

(51) Int. Cl. G02F 1/137; G02F 1/1343; G02F 1/1341

(52) U.S. Cl. CPC G02F 1/137; G02F 1/1341; G02F 1/134309; G02F 2201/121; G02F 2201/123; G02F 2001/134345

(57) ABSTRACT

The present invention discloses a liquid crystal paneland a liquid crystal display. The liquid crystal panel comprises: a first substrate; a second substrate, which is arranged opposite to the first substrate; a liquid crystal layer, which is provided between the first substrate and the second substrate and comprises multiple liquid crystal molecules; an electrode structure, which is arranged on the first substrate or the second substrate, and an electric field is generated in the liquid crystal layer by voltage control, so that the liquid crystal molecule deflects under the effects of the electric field; wherein, the liquid crystal molecule comprises a positive liquid crystal molecule and a negative liquid crystal molecule, the first substrate and the second substrate are divided into multiple pixel regions, each pixel region is further divided into at least two sub-pixel regions, the different sub-pixels in the same pixel region correspond to the liquid crystal molecules with different initial orientations or electrode structures. Through the above way, it is able to enhance the light transmittance of the liquid crystal panel.

### BACKGROUND OF THE INVENTION

1. Field of the Invention

The present invention relates to technical field of liquid crystal display, and in particular to a liquid crystal panel and liquid crystal display.

2. The Related Arts

The liquid crystal is a state of matter between a liquid and a crystalline state. Addition to some properties of both liquid and crystal (such as mobility, anisotropy, etc.), as well as its unique optical properties. The research for liquid crystal has been developed to an impressive subject.

The liquid crystal material is mainly composed of organic matter such as aliphatic compounds, aromatic compounds, and stearic acid. The liquid crystal comprises positive liquid crystal and the negative liquid crystal, and the dielectric anisotropy of liquid crystal is main parameter to determine the behavior of the liquid crystal under the electric field, ε_{//} and ε_{⊥}are used to express the dielectric constant of liquid crystal parallel and vertical to molecular orientation respectively, and each anisotropy is expressed with Δε=ε_{//}−ε_{⊥}. The positive liquid crystal is under conversely the situation of Δε>0, and the negative liquid crystal is under the situation of Δε<0, conversely. The positive liquid crystal molecular is arranged in the field direction under the outer electric field reaction, and the negative liquid crystal molecular is arranged in the direction vertical to field. The positive liquid crystal is mostly used in liquid crystal display field because of the maturity of its supporting material technology and the material itself steady performance. However, the parallel dielectric constant is high, so that the inclination angle between the liquid crystal molecule and the substrate is high, and thus the light transmittance is not high.

### SUMMARY OF THE INVENTION

The technical problem to be solved by the embodiment of the present invention is to provide a liquid crystal panel and display, which are able to enhance the light transmittance of the liquid crystal display.

In order to solve the technical issue, an aspect of the present invention is to provide an liquid crystal panel, comprising: a first substrate; a second substrate, which is arranged opposite to the first substrate; a liquid crystal layer, which is provided between the first substrate and the second substrate and comprises multiple liquid crystal molecules; an electrode structure, which is arranged on the first substrate or the second substrate, and an electric field being generated in the liquid crystal layer by voltage control, so that the liquid crystal molecule deflects under the effects of the electric field; wherein, the liquid crystal molecule comprises a positive liquid crystal molecule and a negative liquid crystal molecule, the first substrate and the second substrate are divided into multiple pixel regions, each pixel region is further divided into at least two sub-pixel regions, the different sub-pixels in the same pixel region correspond to the liquid crystal molecules with different initial orientations or electrode structures.

Wherein, a dividing wall is arranged within the sub-pixel regions, and the positive liquid crystal molecule and the negative liquid crystal molecule are separately arranged at different sub-pixel regions of the same pixel region by the dividing wall, and the initial orientation of the positive liquid crystal molecule is different from the initial orientation of the negative liquid crystal molecule.

Wherein, the positive liquid crystal molecule and the negative liquid crystal molecule are arranged by mixing method, the initial orientations of the positive liquid crystal molecule and the negative liquid crystal molecule, at the same sub-pixel region of the same pixel region, are the same as each other; and the initial orientations of the positive liquid crystal molecule and the negative liquid crystal molecule, at different sub-pixel regions of the same pixel region, are different from each other.

Wherein, the electrode structures at different sub-pixel regions of the same pixel region are the same.

Wherein, a dividing wall is arranged within the sub-pixel regions, the positive liquid crystal molecule and the negative liquid crystal molecule are separately arranged at different sub-pixel regions of the same pixel region by the dividing wall, and the electrode structures at different sub-pixel regions of the same pixel region are different from each other.

Wherein, the positive liquid crystal molecule and the negative liquid crystal molecule are arranged by mixing method, and the electrode structures at different sub-pixel regions of the same pixel region are different from each other.

Wherein, the initial orientations of the positive liquid crystal molecule and the negative liquid crystal molecule, at different sub-pixel regions of the same pixel region, are the same.

Wherein, the electrode structures, at different sub-pixel regions of the same pixel region, separately proceed with voltage control.

Wherein, the electrode structures, at different sub-pixel regions of the same pixel region, separately or commonly proceed with voltage control.

In order to solve the technical issue, another aspect of the present invention is to provide an liquid crystal display, comprising a liquid crystal panel, the liquid crystal panel comprising: a first substrate; a second substrate, which is arranged opposite to the first substrate; a liquid crystal layer, which is provided between the first substrate and the second substrate and comprises multiple liquid crystal molecules; an electrode structure, which is arranged on the first substrate or the second substrate, and an electric field being generated in the liquid crystal layer by voltage control, so that the liquid crystal molecule deflects under the effects of the electric field; wherein, the liquid crystal molecule comprises a positive liquid crystal molecule and a negative liquid crystal molecule, the first substrate and the second substrate are divided into multiple pixel regions, each pixel region is further divided into at least two sub-pixel regions, the different sub-pixels in the same pixel region correspond to the liquid crystal molecules with different initial orientations or electrode structures.

Wherein, a dividing wall is arranged within the sub-pixel regions, and the positive liquid crystal molecule and the negative liquid crystal molecule are separately arranged at different sub-pixel regions of the same pixel region by the dividing wall, and the initial orientation of the positive liquid crystal molecule is different from the initial orientation of the negative liquid crystal molecule.

Wherein, the positive liquid crystal molecule and the negative liquid crystal molecule are arranged by mixing method, the initial orientations of the positive liquid crystal molecule and the negative liquid crystal molecule, at the same sub-pixel region of the same pixel region, are the same as each other; and the initial orientations of the positive liquid crystal molecule and the negative liquid crystal molecule, at different sub-pixel regions of the same pixel region, are different from each other.

Wherein, the electrode structures at different sub-pixel regions of the same pixel region are the same.

Wherein, a dividing wall is arranged within the sub-pixel regions, the positive liquid crystal molecule and the negative liquid crystal molecule are separately arranged at different sub-pixel regions of the same pixel region by the dividing wall, and the electrode structures at different sub-pixel regions of the same pixel region are different from each other.

Wherein, the positive liquid crystal molecule and the negative liquid crystal molecule are arranged by mixing method, and the electrode structures at different sub-pixel regions of the same pixel region are different from each other.

Wherein, the initial orientations of the positive liquid crystal molecule and the negative liquid crystal molecule, at different sub-pixel regions of the same pixel region, are the same.

Wherein, the electrode structures, at different sub-pixel regions of the same pixel region, separately proceed with voltage control.

Wherein, the electrode structures, at different sub-pixel regions of the same pixel region, separately or commonly proceed with voltage control.

The beneficial effects of the embodiment of the invention are as follows. Distinguishing from the prior art, the liquid crystal molecule according to the present invention comprises a positive liquid crystal molecule and a negative liquid crystal molecule, the first substrate and the second substrate are divided into multiple pixel regions, each pixel region is further divided into at least two sub-pixel regions, the different sub-pixels in the same pixel region correspond to the liquid crystal molecules with different initial orientations or electrode structures, which is able to enhance the light transmittance of the liquid crystal panel.

### BRIEF DESCRIPTION OF THE DRAWINGS

FIG. 1 is the schematic diagram of an liquid crystal panel according to the embodiment of the present invention;

FIG. 2 is the schematic diagram of the pixel structure according to the first embodiment of the present invention;

FIG. 3 is the schematic diagram of the pixel structure according to the second embodiment of the present invention;

FIG. 4 is the schematic diagram of the pixel structure according to the third embodiment of the present invention; and

FIG. 5 is the schematic diagram of the pixel structure according to the fourth embodiment of the present invention.

### DETAILED DESCRIPTION OF THE PREFERRED EMBODIMENTS

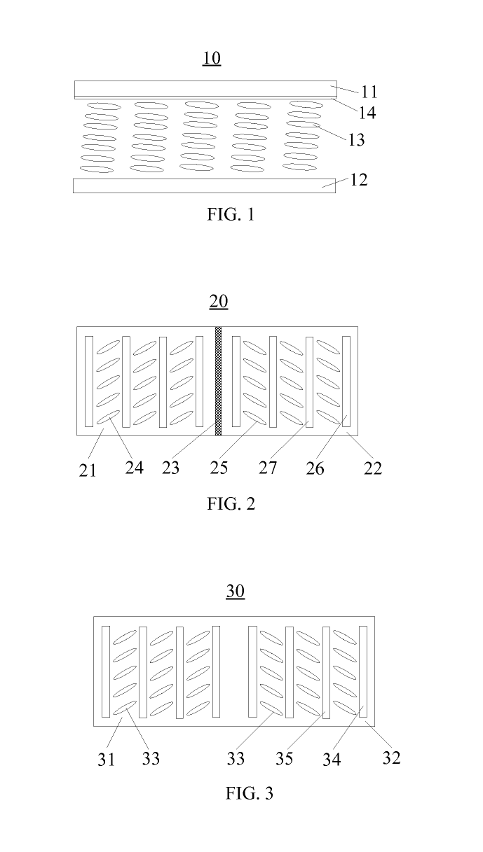

Referring to FIG. 1, which is the schematic diagram of a liquid crystal panel according to the embodiment of the present invention. The liquid crystal panel 10 comprises a first substrate 11, a second substrate 12, a liquid crystal layer 13, and an electrode structure 14 as shown in FIG. 1. The second substrate 12 is arranged opposite to the first substrate. The liquid crystal layer 13 is provided between the first substrate 11 and the second substrate 12, and comprises multiple liquid crystal molecules. The electrode structure 14 is arranged at the first substrate 11 or the second substrate 12, and an electric field is generated in the liquid crystal layer 13 by voltage control, so that the liquid crystal molecule deflects under the effects of the electric field.

In present embodiment of this invention, the liquid crystal molecule comprises a positive liquid crystal molecule and a negative liquid crystal molecule. As the vertical dielectric constant of the negative liquid crystal molecule is higher, so that the inclination angle between the liquid crystal molecule and the substrate is smaller, as well as the negative liquid crystal molecule being rotating more parallel to the substrate to increase the transmittance of the liquid crystal panel. The first substrate 11 and the second substrate 12 are divided into multiple pixel regions, each pixel region is further divided into at least two sub-pixel regions, and the different sub-pixels in the same pixel region correspond to the liquid crystal molecules with different initial orientations or electrode structures 14.

FIG. 2 is the schematic diagram of the pixel structure according to the first embodiment of the present invention. The pixel structure 20 is divided into the first sub-pixel region 21 and second sub-pixel region 22 as shown in FIG. 2. A dividing wall 23 is arranged between the first sub-pixel region 21 and the second sub-pixel region 22. The positive liquid crystal molecule 24 and the negative liquid crystal 25 molecule are separately arranged at different sub-pixel regions of the same pixel region by the dividing wall 23. For example, the positive liquid crystal molecule 24 is injected into the first sub-pixel region 21, and the negative liquid crystal molecule 25 is injected into the second sub-pixel region 22. Furthermore, in the other embodiments of the present invention, the negative liquid crystal molecule 25 is injected into the first sub-pixel region 21, and the positive liquid crystal molecule 25 is injected into the second sub-pixel region 22. The initial orientation of the positive liquid crystal molecule 24 is different with the initial orientation of the negative liquid crystal molecule 25. The different initial orientations of the positive liquid crystal molecule 24 and the negative liquid crystal molecule 25 are realized by optical alignment technology. The electrode structure comprises a pixel electrode 26 and a common electrode 27, and the positive liquid crystal molecule 24 and the negative liquid crystal molecule 25 are arranged between the pixel electrode 26 and the common electrode 27. The electrode structures at different sub-pixel regions of the same pixel region are the same. For example, the pixel electrode 26 and the common electrode 27 at the first sub-pixel region 21 and the first sub-pixel region 22 are arranged longitudinally or transversely, which is not limited hereof. As they are working, the electrode structures, at different sub-pixel regions of the same pixel region, are separately or jointly controlled with voltage to realize the display of different sub-pixel regions. As the vertical dielectric constant of the negative liquid crystal molecule is higher, so that the inclination angle between the liquid crystal molecule and the substrate is smaller, as well as the negative liquid crystal molecule being rotating more parallel to the substrate to increase the light transmittance of the liquid crystal panel.

FIG. 3 is the schematic diagram of the pixel structure according to the second embodiment of the present invention. The pixel structure 30 is divided into the first sub-pixel region 31 and second sub-pixel region 32 as shown in FIG. 3. A dividing wall is arranged between the first sub-pixel region 31 and the second sub-pixel region 32. The positive liquid crystal molecule and the negative liquid crystal molecule are arranged by mixing method, to mixed liquid crystal 33. The initial orientations of the positive liquid crystal molecule and the negative liquid crystal molecule, at the same sub-pixel region of the same pixel region, are the same, and the initial orientations of the positive liquid crystal molecule and the negative liquid crystal molecule, at different sub-pixel regions of the same pixel region, are different. The different initial orientations of the positive liquid crystal molecule and the negative liquid crystal molecule, at different sub-pixel regions of the same pixel region, are realized by an optical alignment technology. The electrode structure comprises a pixel electrode 34 and a common electrode 35, and the positive liquid crystal molecule 34 and the negative liquid crystal molecule 35 are arranged between the pixel electrode 34 and the common electrode 35. The electrode structures at different sub-pixel regions of the same pixel region are the same as each other. For example, the pixel electrode 34 and the common electrode 35 at the first sub-pixel region 31 and the first sub-pixel region 32 are arranged longitudinally or transversely, which is not limited hereof. As they are working, the electrode structures, at different sub-pixel regions of the same pixel region, are separately or jointly controlled with voltage to realize the display of different sub-pixel regions. The vertical dielectric constant of the negative liquid crystal molecule is higher, so that the inclination angle between the liquid crystal molecule and the substrate is smaller, as well as the negative liquid crystal molecule being rotating more parallel to the substrate to increase the light transmittance of the liquid crystal panel. The experiment proves the light transmittance of the mixed liquid crystal is increased to 3%˜8% compared with the positive liquid crystal.

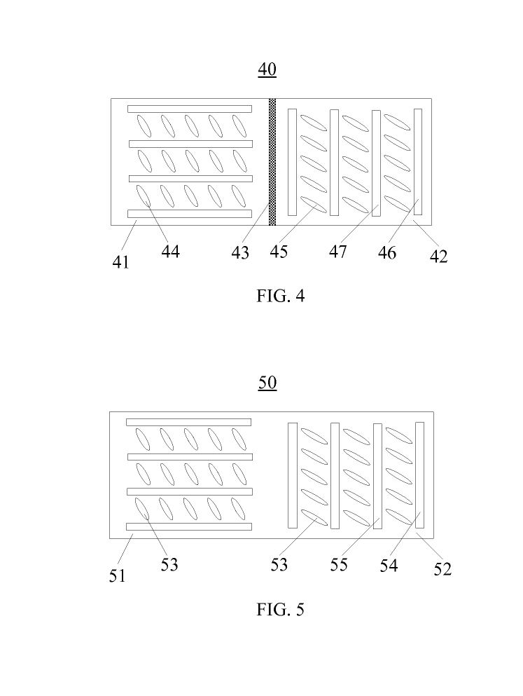

FIG. 4 is the schematic diagram of the pixel structure according to the fourth embodiment of the present invention. The pixel structure 40 is divided into the first sub-pixel region 41 and second sub-pixel region 42 as shown in FIG. 4. A dividing wall 43 is arranged between the first sub-pixel region 41 and the second sub-pixel region 42. The positive liquid crystal molecule 44 and the negative liquid crystal 45 molecule are separately arranged by the dividing wall 43, at different sub-pixel regions of the same pixel region. The initial orientations of the positive liquid crystal molecule 44 and the negative liquid crystal molecule 45, at different sub-pixel regions of the same pixel region, are the same respectively. The electrode structure comprises a pixel electrode 46 and a common electrode 47, and the positive liquid crystal molecule 44 and the negative liquid crystal molecule 45 are arranged between the pixel electrode 46 and the common electrode 47. The electrode structures at different sub-pixel regions of the same pixel region are different from each other. For example, the pixel electrode 46 and the common electrode 47 at the first sub-pixel region 41 are arranged longitudinally, and the pixel electrode 46 and the common electrode 47 at the second sub-pixel region 42 are arranged transversely, which is not limited hereof. As they are working, the electrode structures, at different sub-pixel regions of the same pixel region, separately proceed with voltage control to realize the display of different sub-pixel regions. The vertical dielectric constant of the negative liquid crystal molecule is higher, so that the inclination angle between the liquid crystal molecule and the substrate is smaller, as well as the negative liquid crystal molecule being rotating more parallel to the substrate to increase the light transmittance of the liquid crystal panel.

FIG. 5 is the schematic diagram of the pixel structure according to the fourth embodiment of the present invention. The pixel structure 50 is divided into the first sub-pixel region 51 and second sub-pixel region 52 as shown in FIG. 5. A dividing wall is arranged between the first sub-pixel region 51 and the second sub-pixel region 52. The positive liquid crystal molecule and the negative liquid crystal molecule are arranged by mixing method, to mixed liquid crystal 53. The initial orientations of the positive liquid crystal molecule and the negative liquid crystal molecule, at the same sub-pixel region of the same pixel region, are the same respectively. The electrode structure comprises a pixel electrode 54 and a common electrode 55, and the positive liquid crystal molecule and the negative liquid crystal molecule are arranged between the pixel electrode 54 and the common electrode 55. The electrode structures at different sub-pixel regions of the same pixel region are different from each other. For example, the pixel electrode 54 and the common electrode 55 at the first sub-pixel region 51 are arranged longitudinally, and the pixel electrode 54 and the common electrode 55 at the second sub-pixel region 52 are arranged transversely, which is not limited hereof. As they are working, the electrode structures, at different sub-pixel regions of the same pixel region, are separately or jointly controlled with voltage to realize the display of different sub-pixel regions. The vertical dielectric constant of the negative liquid crystal molecule is higher, so that the vertical dielectric constant of the liquid crystal mixture is increased. Furthermore, the inclination angle between the liquid crystal molecule and the substrate is smaller, as well as the negative liquid crystal molecule being rotating more parallel to the substrate to increase the light transmittance of the liquid crystal panel. The experiments proof the light transmittance of the mixed liquid crystal is higher than the positive liquid crystal with the value of 3%˜8%.

The present invention further provides an liquid crystal display which comprises the aforementioned liquid crystal panel, and the positive liquid crystal molecule the negative liquid crystal molecule in the liquid crystal layer are used simultaneously to assort different electrode structure for forming different pixel structure.

The vertical dielectric constant of the negative liquid crystal molecule is higher, so that the vertical dielectric constant of the liquid crystal mixture is increased. Furthermore, the inclination angle between the liquid crystal molecule and the substrate is smaller, as well as the negative liquid crystal molecule being rotating more parallel to the substrate to increase the light transmittance of the liquid crystal panel. The experiments proof the light transmittance of the mixed liquid crystal is higher than the positive liquid crystal with the value of 3%˜8%.

In summary, the liquid crystal panel according to the present invention comprises: a first substrate; a second substrate, which is arranged opposite to the first substrate; a liquid crystal layer, which is provided between the first substrate and the second substrate and comprises multiple liquid crystal molecules; an electrode structure, which is arranged on the first substrate or the second substrate, and an electric field is generated in the liquid crystal layer by voltage control, so that the liquid crystal molecule deflects under the effects of the electric field; wherein, the liquid crystal molecule comprises a positive liquid crystal molecule and a negative liquid crystal molecule, the first substrate and the second substrate are divided into multiple pixel regions, each pixel region is further divided into at least two sub-pixel regions, the different sub-pixels in the same pixel region correspond to the liquid crystal molecules with different initial orientations or electrode structures, which is able to enhance the light transmittance of the liquid crystal panel.

Finally, it must be noted again that the above described embodiments of the invention only, and not limit the patent scope of the present invention, therefore, the use of all the contents of the accompanying drawings and the description of the present invention is made to equivalent structures or equivalent conversion process, e.g., between the embodiments example technology mutually binding characteristics, directly or indirectly related to the use of technology in other fields, are included within the scope of patent empathy protection of the invention.

What is claimed is:

1. A liquid crystal panel, comprising:
a first substrate;
a second substrate, which is arranged opposite to the first substrate;
a liquid crystal layer, which is provided between the first substrate and the second substrate and comprises multiple liquid crystal molecules;
an electrode structure, which is arranged on the first substrate or the second substrate, and an electric field being generated in the liquid crystal layer by voltage control, so that the liquid crystal molecule deflects under the effects of the electric field;
wherein, the liquid crystal molecule comprises a positive liquid crystal molecule and a negative liquid crystal molecule, the first substrate and the second substrate are divided into multiple pixel regions, each pixel region is further divided into at least two sub-pixel regions, the different sub-pixels in the same pixel region correspond to the liquid crystal molecules with different initial orientations or electrode structures.

2. The liquid crystal panel as claimed in claim 1, wherein a dividing wall is arranged within the sub-pixel regions, and the positive liquid crystal molecule and the negative liquid crystal molecule are separately arranged at different sub-pixel regions of the same pixel region by the dividing wall, and the initial orientation of the positive liquid crystal molecule is different from the initial orientation of the negative liquid crystal molecule.

3. The liquid crystal panel as claimed in claim 1, wherein the positive liquid crystal molecule and the negative liquid crystal molecule are arranged by mixing method, the initial orientations of the positive liquid crystal molecule and the negative liquid crystal molecule, at the same sub-pixel region of the same pixel region, are the same as each other, and the initial orientations of the positive liquid crystal molecule and the negative liquid crystal molecule, at different sub-pixel regions of the same pixel region, are different from each other.

4. The liquid crystal panel as claimed in claim 3, wherein the electrode structures at different sub-pixel regions of the same pixel region are the same.

5. The liquid crystal panel as claimed in claim 1, wherein a dividing wall is arranged within the sub-pixel regions, the positive liquid crystal molecule and the negative liquid crystal molecule are separately arranged at different sub-pixel regions of the same pixel region by the dividing wall, and the electrode structures at different sub-pixel regions of the same pixel region are different from each other.

6. The liquid crystal panel as claimed in claim 1, wherein the positive liquid crystal molecule and the negative liquid crystal molecule are arranged by mixing method, and the electrode structures at different sub-pixel regions of the same pixel region are different from each other.

7. The liquid crystal panel as claimed in claim 6, wherein the initial orientations of the positive liquid crystal molecule and the negative liquid crystal molecule, at different sub-pixel regions of the same pixel region, are the same.

8. The liquid crystal panel as claimed in claim 6, wherein the electrode structures, at different sub-pixel regions of the same pixel region, separately proceed with voltage control.

9. The liquid crystal panel as claimed in claim 3, wherein the electrode structures, at different sub-pixel regions of the same pixel region, separately or commonly proceed with voltage control.

10. The liquid crystal panel as claimed in claim 7, wherein the electrode structures, at different sub-pixel regions of the same pixel region, separately or commonly proceed with voltage control.

11. A liquid crystal display, comprising a liquid crystal panel, the liquid crystal panel comprising:
a first substrate;
a second substrate, which is arranged opposite to the first substrate;
a liquid crystal layer, which is provided between the first substrate and the second substrate and comprises multiple liquid crystal molecules;
an electrode structure, which is arranged on the first substrate or the second substrate, and an electric field being generated in the liquid crystal layer by voltage control, so that the liquid crystal molecule deflects under the effects of the electric field;
wherein, the liquid crystal molecule comprises a positive liquid crystal molecule and a negative liquid crystal molecule, the first substrate and the second substrate are divided into multiple pixel regions, each pixel region is further divided into at least two sub-pixel regions, the different sub-pixels in the same pixel region correspond to the liquid crystal molecules with different initial orientations or electrode structures.

12. The liquid crystal display as claimed in claim 11, wherein a dividing wall is arranged within the sub-pixel regions, and the positive liquid crystal molecule and the negative liquid crystal molecule are separately arranged at different sub-pixel regions of the same pixel region by the dividing wall, and the initial orientation of the positive liquid crystal molecule is different from the initial orientation of the negative liquid crystal molecule.

13. The liquid crystal display as claimed in claim 11, wherein the positive liquid crystal molecule and the negative liquid crystal molecule are arranged by mixing method, the initial orientations of the positive liquid crystal molecule and the negative liquid crystal molecule, at the same sub-pixel region of the same pixel region, are the same as each other; and the initial orientations of the positive liquid crystal molecule and the negative liquid crystal molecule, at different sub-pixel regions of the same pixel region, are different from each other.

14. The liquid crystal display as claimed in claim 13, wherein the electrode structures at different sub-pixel regions of the same pixel region are the same.

15. The liquid crystal display as claimed in claim 11, wherein a dividing wall is arranged within the sub-pixel regions, the positive liquid crystal molecule and the negative liquid crystal molecule are separately arranged at different sub-pixel regions of the same pixel region by the dividing wall, and the electrode structures at different sub-pixel regions of the same pixel region are different from each other.

16. The liquid crystal display as claimed in claim 11, wherein the positive liquid crystal molecule and the negative liquid crystal molecule are arranged by mixing method, and the electrode structures at different sub-pixel regions of the same pixel region are different from each other.

17. The liquid crystal display as claimed in claim 16, wherein the initial orientations of the positive liquid crystal molecule and the negative liquid crystal molecule, at different sub-pixel regions of the same pixel region, are the same.

18. The liquid crystal display as claimed in claim 16, wherein the electrode structures, at different sub-pixel regions of the same pixel region, separately proceed with voltage control.

19. The liquid crystal display as claimed in claim 13, wherein the electrode structures, at different sub-pixel regions of the same pixel region, separately or commonly proceed with voltage control.

20. The liquid crystal display as claimed in claim 17, wherein the electrode structures, at different sub-pixel regions of the same pixel region, separately or commonly proceed with voltage control.
